(19) United States
(12) Patent Application Publication
(10) Pub. No.: US 2005/0081146 A1
(43) Pub. Date: Apr. 14, 2005

(54) Relation chart-creating program, relation chart-creating method, and relation chart-creating apparatus

(75) Inventors: Kazunari Tanaka, Kawasaki (JP); Isamu Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/812,021

(22) Filed: Mar. 30, 2004

(30) Foreign Application Priority Data
Oct. 14, 2003 (JP) 2003-353928

(51) Int. Cl. G06F 17/00

(52) U.S. Cl. 715/517

(57) ABSTRACT

A relation chart-creating program which are capable of clarifying degrees of relevance between documents which do not explicitly-shown citation relationship or reference relationship, and then displaying the documents in chronological order. When a plurality of documents are inputted, contents of each of the documents are analyzed, and feature elements including time information are extracted therefrom. A degree of relevancy is calculated between each document pair extracted from the documents, based on the extracted feature elements. Objects indicative of the documents are arranged along a time axis, based on the time information. Association lines are generated for connecting between the objects of each document pair, depending on the calculated degree of relevancy. The relation chart composed of the objects and the association lines is displayed.

### BACKGROUND OF THE INVENTION

(1) Field of the Invention

This invention relates to a relation chart-creating program, a relation chart-creating method, and a relation chart-creating apparatus, and more particularly to a relation chart-creating program, a relation chart-creating method, and a relation chart-creating apparatus, which are capable of showing associations between documents relevant in contents to each other even when there is no citation relationship or reference relationship therebetween.

(2) Description of the Related Art

Recently, storage media of data have been rapidly increasing in volume and decreasing in prices. Further, along with proliferation of the use of intranets and the Internet, it is possible to view documents stored in servers all over the world. These immense amounts of document information can be easily collected and accumulated using computers, such as clients and the like.

The amount of information on the Internet is too immense to find out a necessary piece of information or produce some finding from the information collected as above, and therefore, a search/analysis tool is indispensable which can retrieve and analyze document information in response to a request from a user.

For the search/analysis tool, there have been proposed a method of selecting and displaying documents which contain words, or a character string designated by a user and a method of selecting and displaying documents having citation relationship or reference relationship therebetween, and a technique of displaying documents in order of time. For example, literature, such as patent publications, can be displayed according to the year of publication (see e.g. Japanese Laid-Open Patent Publication (Kokai) No. 2001-92851 (FIG. 27)).

Further, there has also proposed a technique of drawing a relation chart by associating documents having citation relationship or reference relationship. For example, the present applicant has proposed in Japanese Patent Application No. 2002-179896 and Japanese Patent Application No. 2002-343744, a technique of showing graphs in which association between documents are indicated by lines. If there exists citation relationship, it is obvious that a citing document was written after a document cited by the citing document, so that the before-and-after relationship in time between the documents can be easily grasped.

However, in the technique of drawing a relation chart based on citation relationship and reference relationship, a relation chart cannot be drawn without the citation relationship and the reference relationship. Therefore, even if the documents are closely related to each other, without description of citation relationship or reference relationship therebetween, it is impossible to draw and show the relevance therebetween.

On the other hand, in the field of document search, it is possible to extract keywords or attribute information from documents and even calculate the degree of relevance therebetween. In this case, however, there is a problem of the before-and-after relationship between the documents being made unclear.

### SUMMARY OF THE INVENTION

The present invention has been made in view of the above described points, and an object thereof is to provide an relation chart-creating program, a relation chart-creating method, and a relation chart-creating apparatus which are capable of clarifying degrees of relevance between documents which do not have explicitly-shown citation relationship or reference relationship therebetween, and then displaying the documents in chronological order.

To attain the above object, the present invention provides a relation chart-creating program for creating a relation chart representative of relations between a plurality of documents. The program is characterized by causing a computer to analyze contents of each of the documents and extract feature elements including time information therefrom, calculate a degree of relevancy between each document pair extracted from the documents, based on the extracted feature elements, lay out objects indicative of the documents, along a time axis, based on the time information, and generate association lines for connecting between the objects of each document pair, depending on the calculated degree of relevancy, and display the relation chart composed of the objects and the association lines.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram showing the concept of the present invention applied to a preferred embodiment thereof.

FIG. 2 is a diagram showing an example of the configuration of a system that performs document retrieval via a network.

FIG. 3 is a diagram showing a hardware configuration of a client used in the preferred embodiment of the present invention.

FIG. 4 is a functional block diagram illustrating the functions of a relation chart-creating apparatus.

FIG. 5 is a flowchart showing a procedure of operations executed in a relation chart-creating process.

FIG. 6 is a diagram showing an example of a patent document.

FIG. 7 is a diagram showing an example of a part-of-speech setting screen for setting parts of speech.

FIG. 8 is a diagram showing an example of the part-of-speech setting screen after a part-of-speech selecting section for selecting parts of speech has been scrolled.

FIG. 9 is a diagram showing an example of a data structure of a feature element management table.

FIG. 10 is a diagram showing an example of a document-word matrix.

FIG. 11 is a diagram showing an example of a data structure of document relevancy information.

FIG. 12 is a flowchart showing a procedure of operations executed in a document association-thinning process.

FIG. 13 is a diagram showing an example of a data structure of association-thinning information.

FIG. 14 is a diagram showing an example of a thinning-out setting screen.

FIG. 15 is a flowchart showing a procedure of operations executed in a document layout-calculating process.

FIG. 16 is a diagram showing document objects arranged at random.

FIG. 17 is a diagram showing document objects arranged along the time axis.

FIG. 18 is a diagram showing document objects arranged according to hierarchical levels.

FIG. 19 is a diagram showing a relation chart in which document objects are arranged at respective determined locations.

FIG. 20 is a diagram showing an example of display of a relation chart.

FIG. 21 is a diagram showing an example of a relation chart in which chronological order of all documents is preserved.

FIG. 22 is a diagram showing an example of a relation chart in which association lines including those indicative of associations before thinning-out are displayed.

FIG. 23 is a flowchart showing a procedure of thinning-out associations between documents when citation relationship and reference relationships between documents are taken into account.

### DESCRIPTION OF THE PREFERRED EMBODIMENTS

Hereafter, a preferred embodiment of the present invention will be described with reference to the drawings.

The present invention has been made in view of the problems of the prior art described hereinabove, and makes it possible to associate relevant documents with each other even when the documents are without citation relationship and reference relationship, through utilization of the technique of calculating a degree of relevance between documents, and draw a relation chart by making use of time information.

First, an outline of the invention applied to the preferred embodiments thereof will be described, and then, details of the preferred embodiment will be described.

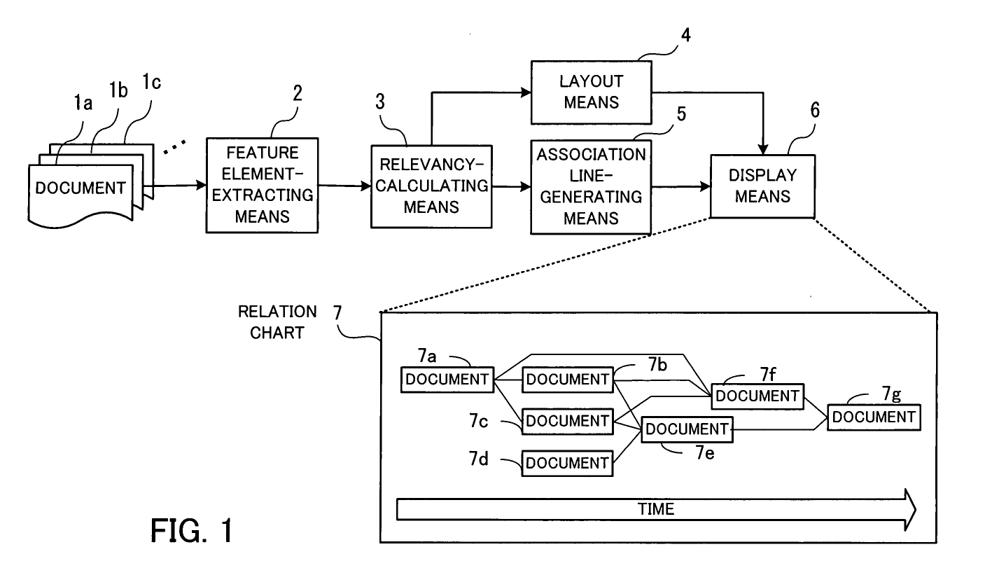

FIG. 1 is a diagram showing the concept of the invention applied to the preferred embodiment thereof. A relation chart-creating apparatus according to the present invention is for drawing a chart showing relationship between a plurality of documents 1a, 1b, 1c, . . . The relation chart-creating apparatus is comprised of feature element-extracting means 2, relevancy-calculating means 3, layout means 4, association line-generating means 5, and display means 6.

The feature element-extracting means 2 analyzes contents of a plurality of documents 1a, 1b, 1c, . . . , and extracts feature elements including time information. The feature elements include e.g. keywords and bibliographic information.

The relevancy-calculating means 3 calculates a degree of relevance between each document pair extracted from the plurality of documents 1a, 1b, 1c, . . . , based on the extracted feature elements. The calculation of relevance is carried out e.g. such that the relevance between documents containing a larger number of identical keywords is higher than those containing a smaller number of the identical keywords.

The layout means 4 arranges objects 7a to 7g indicative of the documents 1a, 1b, 1c, . . . , respectively, along the time axis according to the time information. In doing this, it is not necessary to preserve a before-and-after relationship in time between all the documents. For example, the apparatus can be configured such that the documents are displayed while maintaining the before-and-after relationship between documents each of document pairs having a predetermined or higher relevance therebetween.

The association line-generating means 5 generates association lines connecting between the document pairs of objects 7a to 7g depending on the calculated degree of relevancy. It is not necessary to connect objects of all document pairs. For example, it is possible to perform thinning-out of associations between documents according to predetermined conditions, and generate association lines only according to the associations remaining after the thinning-out operation. Further, the association lines can be displayed in a different form (e.g. color, thickness of lines) depending on the degree of relevance between the documents. For example, an association line indicating a higher degree of relevance can be displayed in a highlighted fashion.

The display means 6 displays a relation chart 7 composed of objects and association lines.

According to the relation chart-creating apparatus described above, when a plurality of documents 1a, 1b, 1c, . . . , are inputted, the feature element-extracting means 2 extracts feature elements including time information from the documents 1a, 1b, 1c, . . . The relevancy-calculating means 3 calculates degrees of relevance between documents based on the feature elements extracted from the documents 1a, 1b, 1c, . . . Further, the layout means 4 arranges the objects 7a to 7g indicative of the documents along the time axis based on the time information extracted from the documents 1a, 1b, 1c, . . . Further, the association line-generating means 5 generates association lines connecting between the objects based on the degrees of relevance between the documents 1a, 1b, 1c, . . . Then, the display means 6 displays the relation chart 7 composed of the objects 7a to 7g indicative of the respective documents and the association lines.

For example, in the illustrated relation chart 7 thus generated, the objects 7a to 7g indicative of the documents are arranged along the time axis. The objects 7a to 7g are connected by association lines indicative of satisfaction of a predetermined conditions (not discarded for thinning-out). Then, each pair of objects connected by one association line are arranged in positional relationship along the time axis in a manner conforming to the time information. For example, as the date indicated by the time information of a document is later, the object of the document is displayed in a manner more shifted toward the right side.

Thus, by making use of the technique of calculating degrees of relevance between documents, it is possible to associate documents relevant to each other even when they do not have citation relationship or reference relationship, and generate a relation chart by making use of time information. Moreover, it is possible to easily understand before-and-after relationship in time between documents relevant to each other.

Next, a detailed description will be given of the preferred embodiment of the present invention. In the present embodiment, it is assumed that a large amount of documents are collected via a network, and a relation chart of documents in chronological order is created.

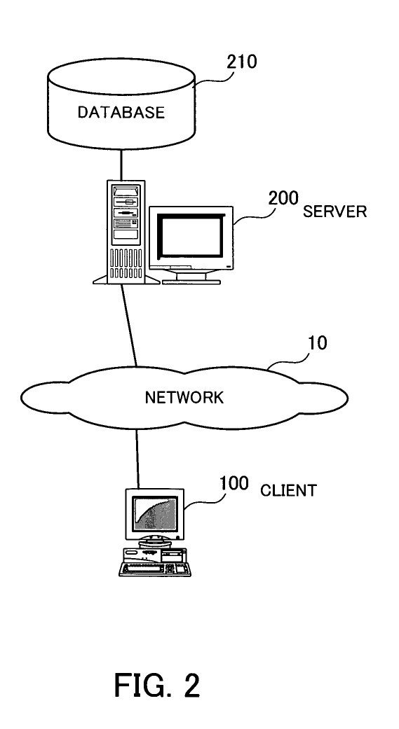

FIG. 2 is a diagram showing an example of the configuration of a system that performs document retrieval via a network. A client 100 is connected to a server 200 via the network 10. The server 200 has a database 210 that stores a vast amount of documents, such as patent documents.

The user is capable of obtaining documents by accessing the server 200 using the client 100. For example, the user sends a search request from the client 100 to a search engine (function of performing database search) installed in the server 200. If the database stores patent documents, it is possible to use a technical term or an international patent classification code as a search key. The server 200 performs search in the database 210 in response to the search request, and returns documents which satisfy search conditions as a result of the search to the client 100.

The client 100 is capable of analyzing the documents contained in the search result, and creating a relation chart in which pieces of information indicative of documents are arranged in chronological order. Further, the server 200 may be configured to analyze documents contained in the search result, create a relation chart, and send data of the relation chart to the client 100.

Although FIG. 2 shows only one server 200, when the document search is performed via a wide area network, such as the Internet, the document search may be executed using a large number of servers.

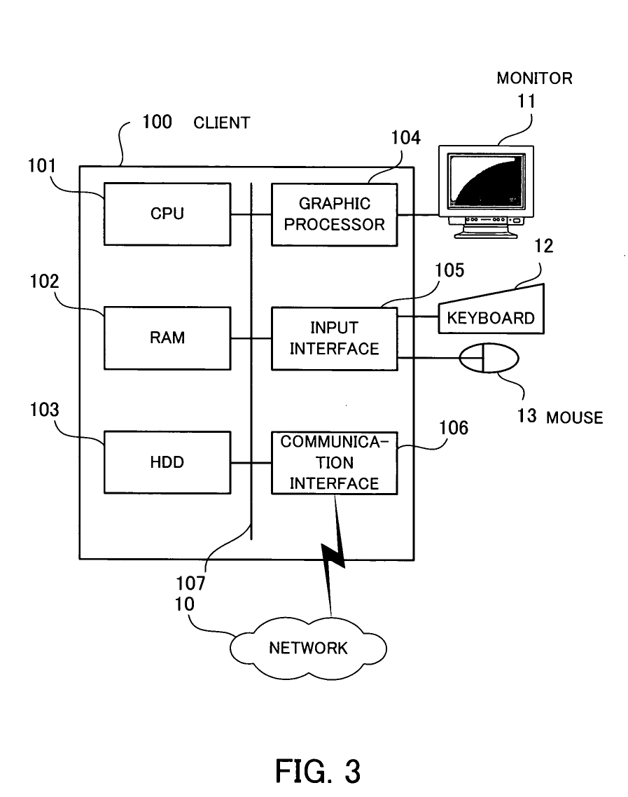

FIG. 3 is a diagram showing an example of a hardware configuration of a client used in the embodiment of the present invention. The whole system of the client 100 is controlled by a CPU (Central Processing Unit) 101. A RAM (Random Access Memory) 102, a hard disk drive (HDD) 103, a graphic processor 104, an input interface 105, and a communication interface 106 are connected to the CPU 101 via a bus 107.

The RAM 102 temporarily stores at least part of an OS (operating system) and application programs executed by the CPU 101. Further, the RAM 102 stores various data necessitated in processing by the CPU 101. The HDD 103 stores the OS and the application programs.

The graphic processor 104 is connected to a monitor 11. The graphic processor 104 displays an image on the screen of the monitor 11 in response to instructions from the CPU 101. A keyboard 12 and a mouse 13 are connected to the input interface 105. The input interface 105 sends signals input from the keyboard 12 and the mouse 13 to the CPU 101 via the bus 107.

The communication interface 106 is connected to the network 10. The communication interface 106 performs transmission and reception of data to and from other computers via the network 10.

The hardware configuration described above can realize the processing functions of the present embodiment.

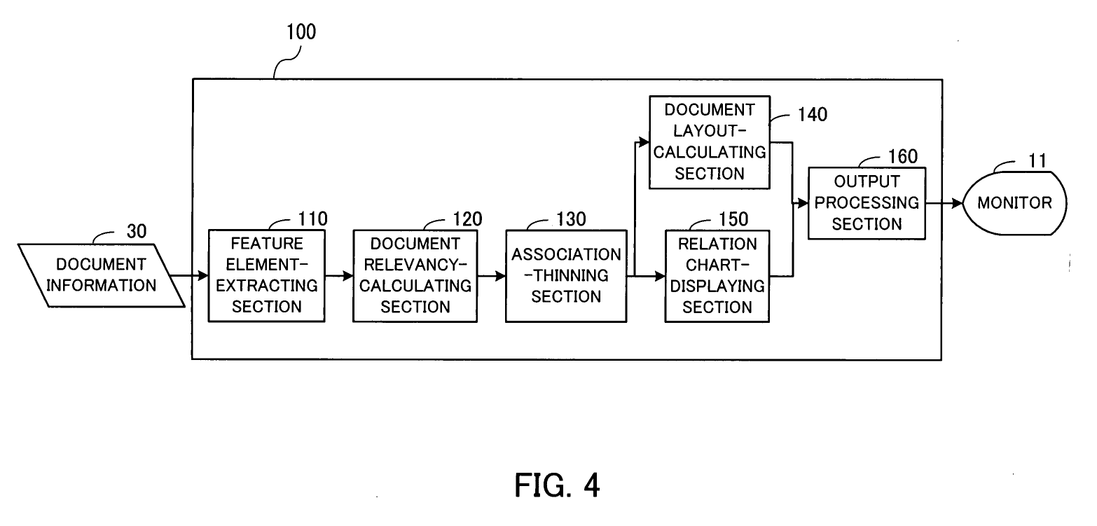

FIG. 4 is a functional block diagram of the functions executed by the client as the relation chart-creating apparatus. The client 100 has a feature element-extracting section 110, a document relevancy-calculating section 120, an association-thinning section 130, a document layout-calculating section 140, a relation chart-displaying section 150, and an output processing section 160. This client 100 starts a relation chart-creating process when document information 30 is inputted thereto.

When the document information 30 is inputted, the feature element-extracting section 110 extracts keywords, bibliographic information, and time information, as feature elements from the document information 30. The feature elements extracted from each of the documents are passed to the document relevancy-calculating section 120.

The document information 30 is e.g. a set of a plurality of documents. The keyword can be extracted e.g. by subjecting each document to morpheme analysis. Further, bibliographic information is e.g. information of the authors of documents, and the like. When the documents are patent documents (laid-open patent publications, patent publications, etc.), it is possible to extract inventors, applicants, patent attorneys, and so forth, as bibliographic information.

The time information extracted from the documents includes e.g. the date of creation of each document, or the date of a latest update thereof. Further, when the documents are patent documents, it is possible to extract a date of laid-open publication, a date of registration, a priority date, and so forth, as the time information.

The document relevancy-calculating section 120 calculates relevancy between documents by using the extracted feature elements. More specifically, as the feature elements of documents have a more similar relevancy, the documents are evaluated to have a higher relevancy. For example, a vector representative of features is calculated based on the extracted feature elements on a document-by-document basis. Then, depending on the closeness of vectors of documents (depending on the value of the inner product of the vectors thereof), the relevancy between the documents is calculated.

The association-thinning section 130 selects necessary associations from associations obtained by the document relevancy-calculating section 120. In other words, from information representative of associations between documents, unnecessary pieces of information are discarded. For example, by setting a threshold value of relevancy, only relations above the threshold value are selected.

The document layout-calculating section 140 determines layout of documents on the relation chart by making use of the degrees of relevancy between documents. More specifically, by referring to the associations made between documents, the layout of documents is determined while maintaining the before-and-after relationship of associated documents in chronological order.

The relation chart-displaying section 150 determines display attributes of association lines on the relation chart by making use of degrees of relevancy between documents. For example, association lines connecting documents having a higher relevancy are displayed in a highlighted fashion.

The output processing section 160 actually displays the relation chart based on the document layout determined by the document layout-calculating section 140 and the display attributes of association lines determined by the relation chart-displaying section 150.

Next, a description will be given of the operation of the client 100 having the above-described construction, which is performed in response to inputting of the document information 30 thereto.

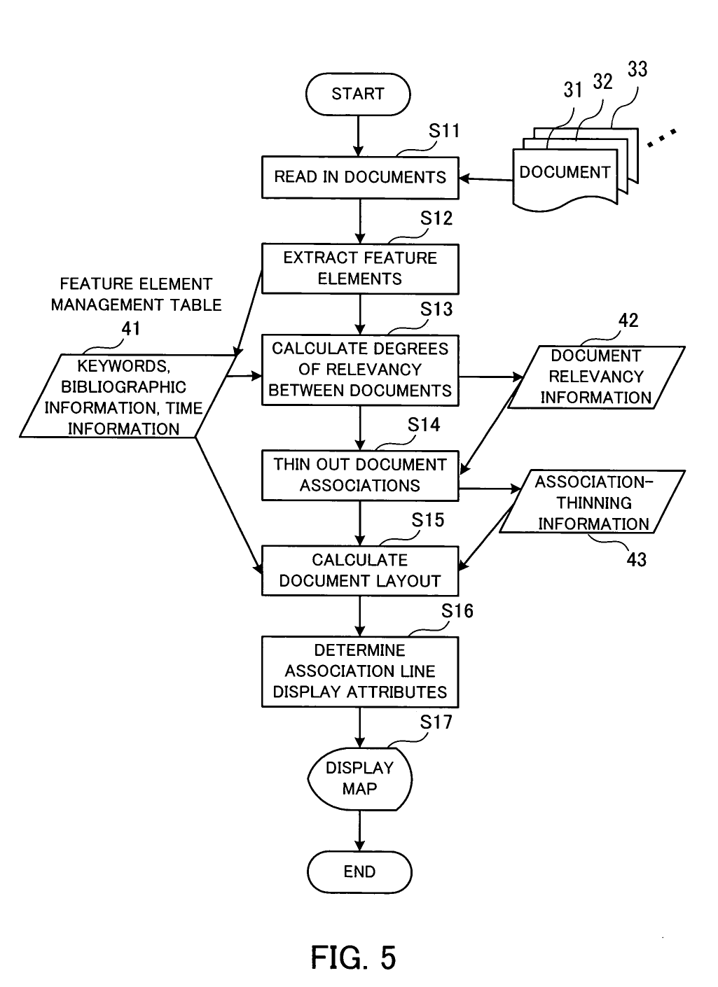

FIG. 5 is a diagram showing a procedure of operations executed in the relation chart-creating process by the client 100. Hereafter, the description will be made in order of step numbers shown in FIG. 5.

[Step S11] The feature element-extracting section 110 reads in a plurality of documents 31, 32, 33,

[Step S12] The feature element-extracting section 110 extracts feature elements, such as keywords, bibliographic information, and time information, from the documents, on a document-by-document basis, and creates a feature element management table 41. The feature element management table 41 stores information of feature elements extracted from each document.

[Step S13] The document relevancy-calculating section 120 refers to the feature element management table 41, and calculates degrees of relevancy between documents. Document relevancy information 42 is defined for documents determined to have a relevancy by the relevancy calculation.

[Step S14] The association-thinning section 130 refers to the document relevancy information 42, and thins out information of the associations by eliminating unnecessary pieces of association information. The thinned association information is set to association-thinning information 43.

[Step S15] The document layout-calculating section 140 refers to the feature element management table 41 and the association-thinning information 43, and determines the layout of objects representative of documents in chronological order.

[Step S16] The relation chart-displaying section 150 determines display attributes of association lines to be displayed, such as thickness and color of each line.

[Step S17] The output processing section 160 arranges objects representative of documents at respective locations determined by the document layout-calculating section 140, and connects between the objects by the association lines having the display attributes determined by the relation chart-displaying section 150, thereby generating a relation chart. Then, the output processing section 160 displays the relation chart on the monitor 11.

Thus, the objects representative of the documents can be displayed in the relation chart in chronological order. By the way, document information desired to be displayed in chronological order includes patent documents. The patent documents are often referred to as known art in determining novelty of each patent application. Therefore, the date of publication or laid-open publication of each document is very important. Therefore, when a plurality of patent documents are retrieved from the database of patent documents, it is desirable to display the retrieved documents in chronological order. To this end, the details of processing executed in each of the steps shown in FIG. 5 will be described by taking an example of patent documents being input as the plurality of documents 31, 32, 33, . . .

[Reading of Documents (Step S11)]

First, the processing of reading documents will be described in detail. Some documents to be read in, such as patent documents, contain bibliographical information.

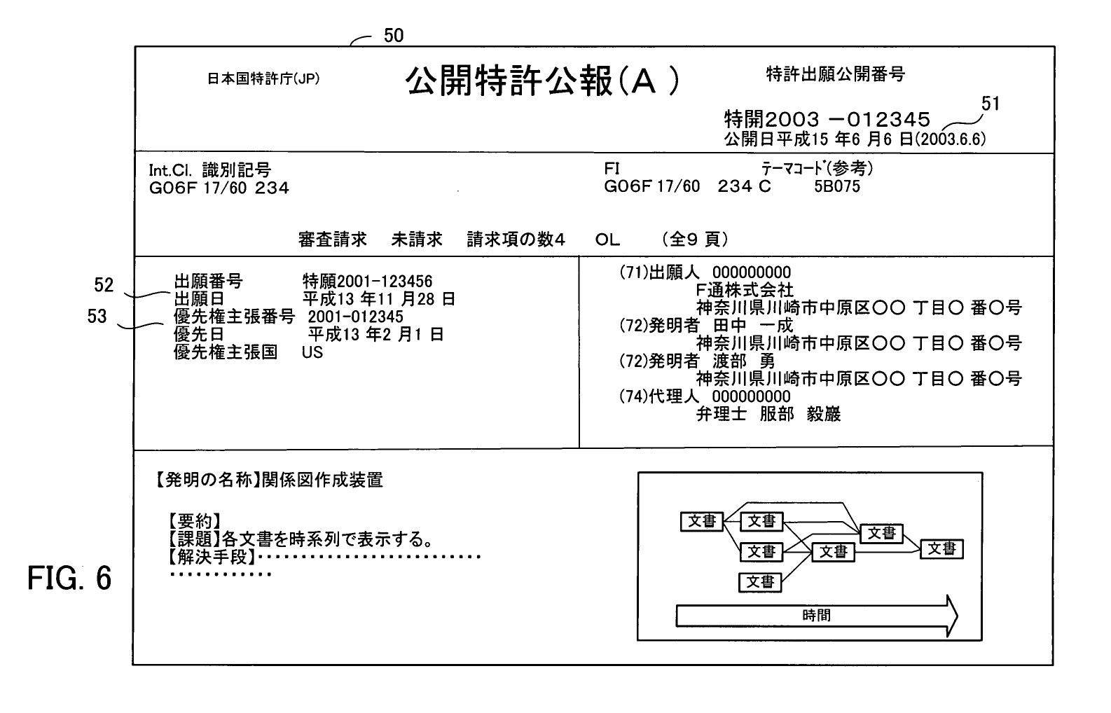

FIG. 6 shows an example of a patent document. In FIG. 6, the front page of a patent document 50 is shown. The front page of the patent document 50 contains description of various bibliographic items. The bibliographic items include time information, such as a date of laid-open publication 51, a date of application 52, and a priority date 53.

A plurality of such patent documents 50 are input to the client 100. For example, as a result of search of the database 210, a plurality of patent documents are obtained. The obtained patent documents are passed to the feature element-extracting section 110.

[Extraction of Feature Elements (Step S12)]

The feature element-extracting section 110 extracts keywords and bibliographic information. As the method of extracting keywords from the documents, there have been proposed various techniques. For example, the feature element-extracting section 110 divides text of the document into words. Then, the feature element-extracting section 110 determines a part of speech of each word. Then, the feature element-extracting section 110 extracts specific parts of speech (e.g. nouns, verbs, etc.) from the documents. What parts of speech should be extracted can be set by the user as desired. For example, the feature element-extracting section 110 displays a part-of-speech setting screen on the monitor 11, and the user can designate parts of speech to be extracted as the feature elements.

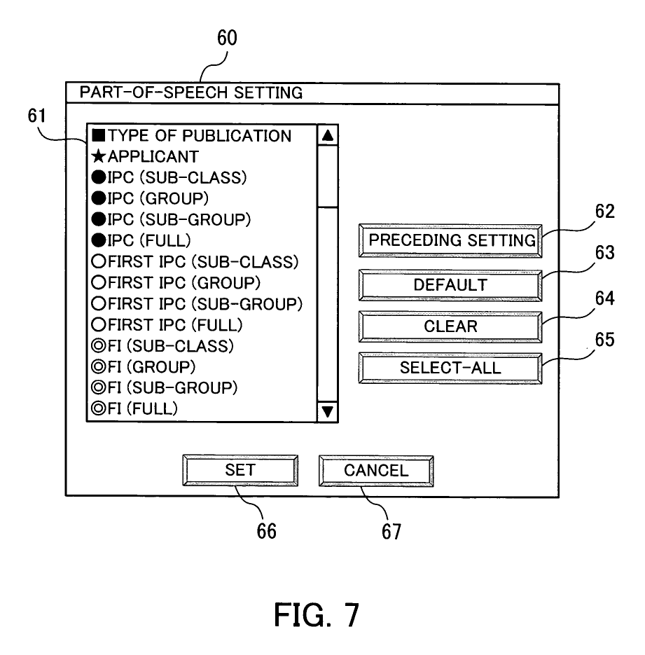

FIG. 7 shows an example of the part-of-speech setting screen. On the part-of-speech setting screen 60, there are provided a preceding set button 62, a default button 63, a clear button 64, a select-all button 65, a set button 66, and a cancel button 67.

On a part-of-speech selecting section 61, there are displayed a list of parts of speech to be obtained by morpheme analysis carried out on documents. In the illustrated example, the name of an item of bibliographic information is also treated as a part-of-speech, and displayed on the part-of-speech selecting section 61. The user can select parts of speech to be extracted as keywords, from the part-of-speech selecting section 61.

The preceding set button 62 is for restoring the immediately preceding settings after the settings of parts of speech to be extracted as keywords have been changed. When an erroneous setting operation is made, by pushing the preceding set button 62, it is possible to restore the immediately preceding settings.

The default button 63 is for setting parts of speech to be extracted as keywords to parts of speech designated in advance. The client 100 has initial values of the parts of speech to be extracted set thereto, and when the default button 63 is pushed, only the parts of speech set as the initial values are set to the parts of speech of keywords to be extracted.

The clear button 64 is for changing the states of parts of speech selected by the part-of-speech selecting section 61 to unselected states.

The select-all button 65 is to select all parts of speech in the part-of-speech selecting section 61.

The set button 66 is for setting parts of speech selected by the part-of-speech selecting section 61 to parts of speech to be extracted.

The cancel button 67 is for closing the part-of-speech setting screen 60 without changing the settings of parts of speech to be extracted.

It should be noted that when all the parts of speech cannot be displayed in one screen, the part-of-speech selecting section 61 can be caused to scroll the contents thereof using a scroll bar to thereby display all of them.

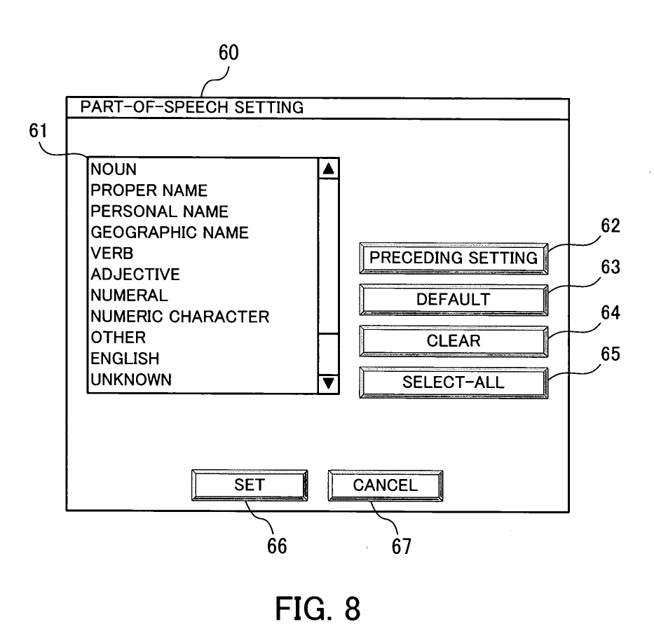

FIG. 8 is a diagram showing an example of the part-of-speech setting screen after scrolling of the part-of-speech selecting section 61. As shown in FIG. 8, the contents to be displayed in the part-of-speech selecting section 61 can be scrolled.

As described above, parts of speech to be used for calculation of relevancy between documents can be designated via the part-of-speech setting screen 60, For example, by default, nouns and proper names are set to parts of speech which can be set to keywords, and IPC (International Patent Classification) and applicant name can be selected as desired, whereby the relevancy between documents can be calculated using these pieces of information.

It should be noted that there can be envisaged various methods of extracting bibliographic information from documents. For example, some document files contain the name of a creator thereof and the date of creation thereof which are registered therein as a profile. The contents of the profile can be extracted as bibliographic information.

When items of bibliographic information are provided in a document as in the case of patent documents, it is possible to extract information registered therein by determining the kind (Inventors, Applicant, etc.) of each item. The bibliographic information includes time information. The time information contained in the patent documents include a date of application, a priority date, a date of publication, a date of registration, and so forth.

The feature element-extracting section 110 forms a feature element management table 41 using the extracted keywords and bibliographic information.

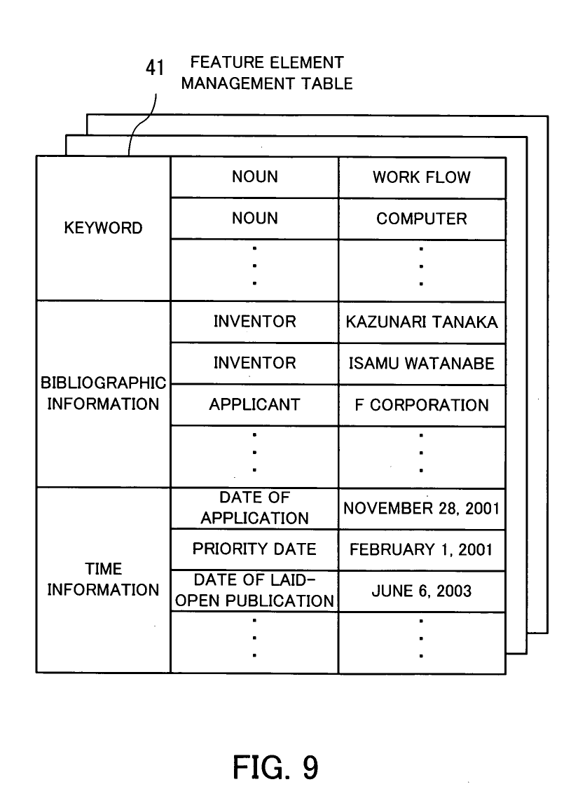

FIG. 9 is a diagram showing an example of a data structure of the feature element management table. The feature element management table 41 stores feature elements of each document classified according to the keywords, bibliographic information, and time information.

For example, the classification item of keywords stores a set of character strings representative of keywords and parts of speech (nouns, verbs, etc.). The classification item of bibliographic information stores a set of items of bibliographic particulars and contents thereof. Assuming that the document is a patent document, as bibliographic information, there are registered Inventors, Applicant, etc. The classification item of time information stores an item related to time, and a date or a date and time set to the item. Assuming that the document is a patent document, as time information, there are registered a date of application, a priority date, and a date of publication, etc.

The above description has been made assuming parts of speech of feature elements to be extracted are selected. However, all parts of speech may be selected by the feature element-extracting section 110, and the calculation of relevancy may be carried out using only feature elements belonging to parts of speech selected when the calculation is carried out by the document relevancy-calculating section 120.

[Calculation of Relevancy Between Documents (Step S13)]

Thereafter, the relevancy between documents is calculated by making use of the feature element management table 41 prepared for each document. For example, from the keywords in the feature element management table 41, a document-word matrix is defined.

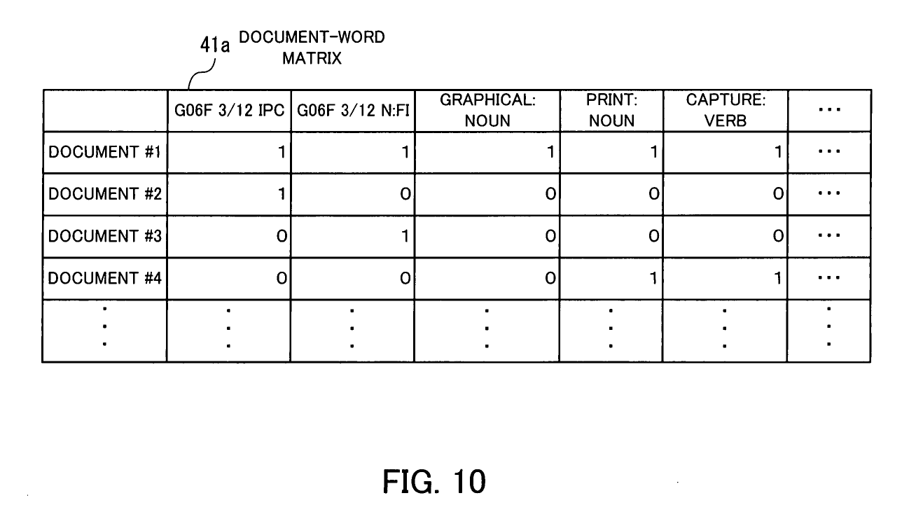

FIG. 10 is a diagram showing an example of the document-word matrix. In the document-word matrix 4la, document names are set to rows, respectively, and keywords are set to columns, respectively. The number of hits of a keyword in a document is set to a box defined by an intersection of a row and a column.

Although in the example shown in FIG. 10, as a simplest value, each box corresponding to a document name and a keyword stores the number of words as hits of the keyword, this is not limitative, but the weighting of each keyword in the document may be stored. Further, to enable discrimination between parts of speech used in the calculation of relevancy, each keyword has the name of a part of speech attached thereto.

The calculation of relevancy between documents can be carried out using the document-word matrix described above. The method of calculation of the relevancy between documents can be realized by a known technique. For example, a method called a vector-space model is known. In the vector-space model, features of each document are represented by certain unified expressions, and degrees of similarity between them are defined to find out documents having a similarity.

That is, features of each document are expressed by a vector. The vector is determined depending on feature elements extracted from the document. The similarity between two documents can be determined by the inner product of respective vectors corresponding to the documents. A larger value of the inner product of the vectors indicates a larger degree of similarity. By regarding the similarity in the vector-space model as the relevancy between documents, it is possible to determine the relevancy between the documents. Details of the vector-space model are described in “Makoto Nagao, Satoshi Satoh, Sadao Kurohashi, and Tatsuhiko Tsunoda, “Natural Language Processing” Iwanami Shoten, Apr. 26, 1996, PP. 421-424”.

There is a problem of which feature elements should be used in calculating the relevancy between documents. A generally known method is to extract keywords from a document, and the keywords are made use of as the feature elements. However, in the present embodiment, the relevancy may be calculated by a method using not only keywords but also bibliographic information.

The bibliographic information is intended here to mean e.g. Applicant, Inventors, Classification Codes, such as IPC, when the calculation is carried out on patent documents. Further, even in the case of documents other than the patent documents, it is possible to make use of information attached to each document, including the name of an author and professional affiliation of the author. It is also possible to make use of information added as extra information, such as an internal-office classification.

Further, as the information to be extracted from documents, it is possible to make use of various kinds of feature characterizing documents, including not only keywords but also relations between keywords, such as a combination of words in a phrase, and feature information extracted according a specific rule.

In this specification, the term “relevancy” is used as a measure of the degree of relevancy between documents, but values thereof are not necessarily required to have a continuous relationship, but may have a 0-or-1 relationship which indicates feature information of whether or not a plurality of documents have a common feature.

The calculated degree of relevancy between documents is registered in the document relevancy information 42.

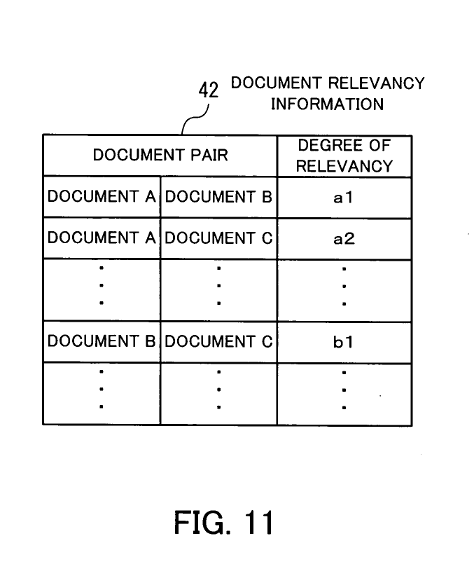

FIG. 11 is a diagram showing an example of a data structure of document relevancy information, i.e. information of degrees of relevancy between documents. In the document relevancy information 42, there are provided e.g. the item of document pair and the item of degree of relevancy.

In the item of document pair, there are registered two documents to be compared in respect of the degree of relevancy. Under this item, there are registered all combinations of two documents selected from input documents 31, 32, 33, . . . Under the item of degree of relevancy, there are registered degrees of relevancy between documents compared.

[Thinning-Out of Document Associations (Step S14)]

Next, a description will be given of a method of selecting only necessary associations for drawing a relation chart from information of degrees of relevancy between documents (method of thinning-out the associations).

When associations between documents for use in calculation of document layout or display attributes of association lines are selected, the relationship between the documents cannot be understood if the documents on the chart are completely made separate from each other and randomly arranged. Therefore, the associations between documents need to be selected such that each of all documents is connected to at least one other document.

For example, the associations are selected from information of degrees of relevancy between documents by the following method:

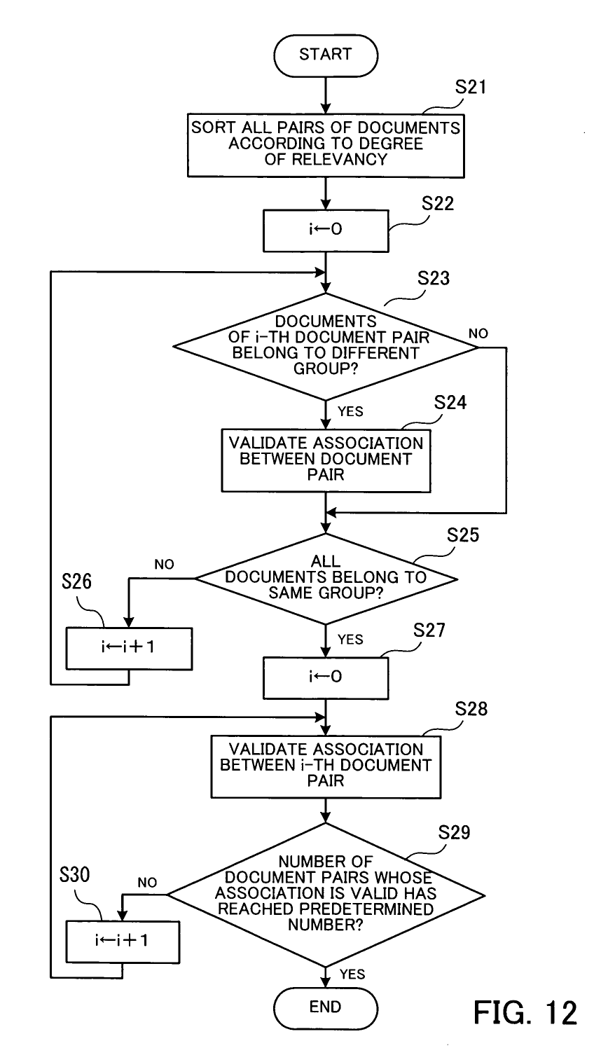

FIG. 12 is a flowchart showing a procedure of a document association-thinning process. Now, the operations shown in FIG. 12 will be described in the order of step numbers.

[Step S21] The association-thinning section 130 sorts all pairs of documents 31, 32, 33, according to the degree of relevancy. The sorted document pairs are each assigned a number in increasing order according to a decreasing order of degrees of relevancy. In an initial state, one document is considered as one group.

[Step S22] The association-thinning section 130 set 0 to a variable i.

[Step S23] The association-thinning section 130 determines whether the documents of an i-th document pair belong to different groups. If they belong to different groups, the process proceeds to a step S24, whereas if they belong to the same group, the process proceeds to a step S25.

[Step S24] The association-thinning section 130 validates the association between the documents of the i-th document pair. More specifically, the association-thinning section 130 sets information indicative of validity of association to a box corresponding to the i-th document pair in the association-thinning information 43. The groups of documents between which the association is validated are integrated into one group.

[Step S25] The association-thinning section 130 determines whether or not all the documents belong to the same group. If all the documents belong to the same group, the process proceeds to a step S27, whereas if there are a plurality of groups, the process proceeds to a step S26.

[Step S26] The association-thinning section 130 increments the value of i (adds 1 to the variable i). Then, the process returns to the step S23, wherein validity of association is determined as to a document pair in the following position in the order of relevancy. The steps from S23 to S25 are repeatedly carried out until all the documents belong to the same group.

Thus, the processing from the steps S21 to S26 validates the association between documents which have a strongest relevancy between them of all document pairs which do not belong to the same group. Then, when a document pair belonging to the same group is checked, the association of the document pair is not validated since the documents already belong to the same group.

[Step S27] The association-thinning section 130 sets 0 to the variable i.

[Step S28] The association-thinning section 130 validates the association between the i-th document pair.

[Step S29] The association-thinning section 130 determines whether or not the number of document pairs each of which has a valid association has reached a predetermined number. If the number of document pairs each of which has a valid association has reached the predetermined number, the present process is terminated, whereas if not, the process proceeds to a step S30.

[Step S30] The association-thinning section 130 increments the value of i (adds 1 thereto). Thereafter, the process proceeds to the step S28.

Thus, from the step S28 to the step S30, the condition of “association is not validated within the same group, even if it is strong” applied in the steps S23 and S24 is removed, but the association is validated in the decreasing order of degrees of relevancy until the number of valid associations reaches a predetermined number (e.g. several tens % of all the possible associations). As a result, there is produced the association-thinning information 43.

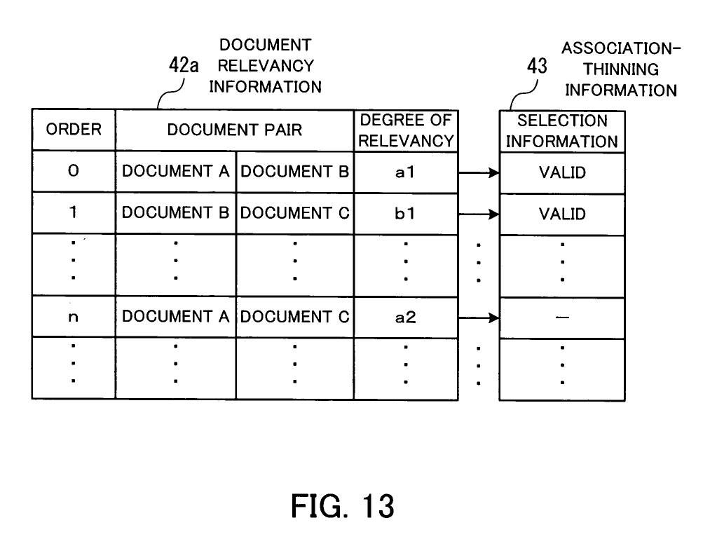

FIG. 13 is a diagram showing an example of a data structure of the association-thinning information. The association-thinning information 43 has selection information corresponding to each document pair in the document relevancy information 42a after sorted according to the degree of relevancy. The selection information has “Valid” set to each document pair whose association is selected to be valid. In other words, the association between each document pair which is set to “Valid” is selected, and the association between each document pair having no setting is discarded for thinning-out.

By the way, the user is capable of setting to a degree of relevancy below which association should be discarded for thinning-out (threshold of the degree of relevancy for thinning-out), as he desires.

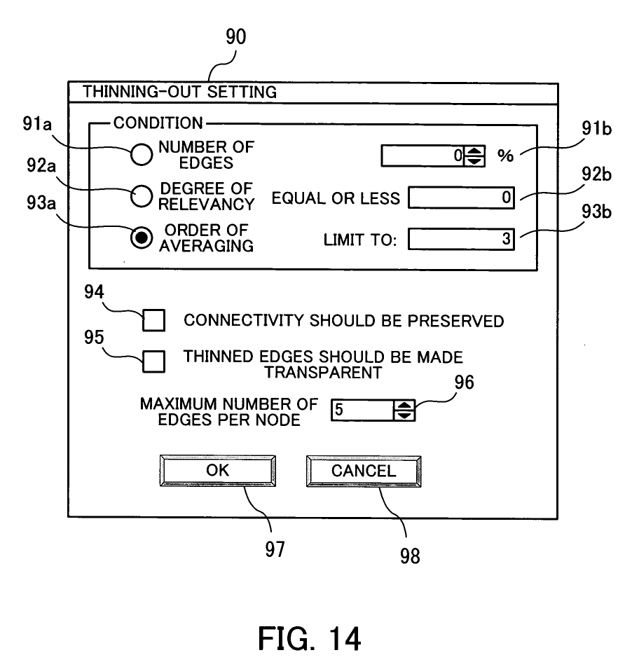

FIG. 14 is a diagram showing an example of a thinning-out setting screen. In the illustrated example of the thinning-out setting screen, it is possible to control thinning-out conditions, such as “number of edges”, “degree of relevancy”, and “order of averaging”. These conditions have the following meanings:

The “number of edges” indicates how many % of all the association lines should be maintained. If a check mark is displayed in a check box 91a, the condition of “number of edges” becomes effective. The ratio of association lines to be maintained can be entered to a text box 91b in percentage.

The “degree of relevancy” indicates a value of the degree of relevancy between documents below which the association lines should be discarded for thinning-out. If a check mark is displayed in a check box 92a, the condition of “degree of relevancy” is effective. The value of degree of relevancy as a threshold value can be entered in a text box 92b by a numerical value.

The “order of averaging” indicates how may association lines per document should remain an average. When a check mark is displayed in a check box 93a, the condition of the “order of averaging” is effective. The “order of averaging” can be entered to a text box 93b by a numerical value.

In the example shown in FIG. 14, it is also possible to select via a check box 94 whether connectivity should be preserved. If the connectivity is set to be preserved, even after thinning-out, all the documents remain connected to at least one document.

Further, via a check box 95, it is possible to select whether edges (association lines) discarded for thinning-out should be made transparent. If the discarded association lines are made transparent, only the degree of relevancy having higher degrees of relevancy are displayed, which makes it easy to grasp the associated conditions between the documents.

There is also provided a text box 96 for setting the “maximum number of edges per node”. This text box 96 is for preventing a radial chart from being formed due to concentration of lines to one document. Even in the case of lines being concentrated to one document, the number set in the text box 96 sets a limit to the number of lines connected to one document.

The method of performing thinning-out based on this limitation has been proposed by the present applicant in Japanese Patent Application No. 2002-179896.

It is possible to set, in advance, default (initial) values to be used as the settings of thinning-out by default. When the thinning-out setting screen 90 is first displayed, it is in the state having the default values set therein. FIG. 14 is assumed to display the default values. In this example, the “order of averaging” is selected as a thinning-out condition, and has a value of 3 set thereto. Further, a value of 5 has been set to the maximum number of edges per node.

In the thinning-out setting screen 90, there are provided an OK button 97 and a cancel button 98. When the OK button 97 is pushed, the conditions set on the thinning-out setting screen 90 are finally determined. When the cancel button 98 is pushed, the thinning-out setting screen 90 is closed without changing the settings.

Thus, the user can set the thinning-out conditions as desired.

It should be noted that lots of other thinning-out methods can be envisaged. For example, it is possible to limit the number of association lines connectible to one document (the number of document pairs in which associations between the one document and its counterparts are made valid).

Further, if there is a substitute path (association made via another document) in the relationship between a document pair, it is possible to invalidate the direct association between the document pair. This technique has been proposed by the present applicant in Japanese Patent Application No. 2002-343744.

Thus, the thinning-out of associations between documents can be performed. As a consequence, when a relation chart is displayed, documents are connected only by important association lines, which facilitates the user's understanding of relations between documents.

[Document Layout Calculation (Step S15)]

Next, a description will be given of a document layout calculation. Here, a method will be described in which documents are laid out such that chronological order is preserved only in documents associated with. For details of the method of document layout which can be employed in the present invention, reference should be made to “Kozo Sugiyama, “Automatic Graph Drawing Method and Application thereof” Corona Publishing Co., Ltd. 1993”. The following description will be given of a relatively simple one of examples of the method described in the above-mentioned reference.

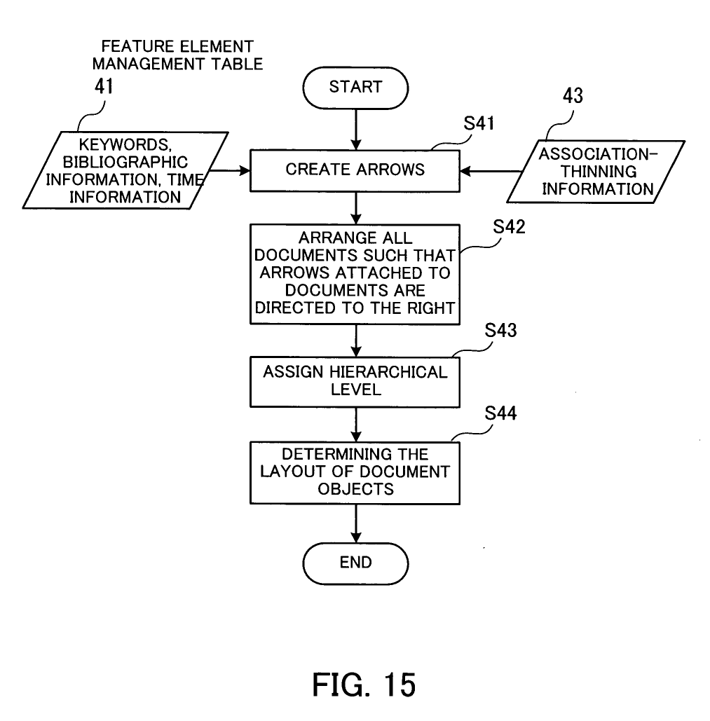

FIG. 15 is a flowchart showing a procedure of steps executed in a document layout-calculating process. Now, the process shown in FIG. 15 will be described in the order of step numbers. In the present embodiment, the time axis is represented by the horizontal axis, and it is assumed that time flows from left to right.

[Step S41] The document layout-calculating section 140 lays out objects indicative of documents (hereinafter referred to as “document objects” at random, and arrows indicative of association between document objects are created using the feature element management table 41 and the association-thinning information 43. More specifically, an arrow is created between documents of each document pair for which association is validated, which is directed from an older one of the pair in chronological order to a later one of the same.

[Step S42] The document layout-calculating section 140 arranges all the documents such that arrows attached to the documents are directed to the right (in the direction of flow of time).

[Step S43] After the document layout-calculating section 140 has finished arranging the document objects, each document object is assigned a hierarchical level. More specifically, the document layout-calculating section 140 sets the “maximum value of the hierarchical levels of document objects connected in series from the left side to a document object to be determined in respect of hierarchical level+1” to a value indicative of the hierarchical level of the document object to be determined.

[Step S44] Finally, the document layout-calculating section 140 determines the layout of document objects. More specifically, the document layout-calculating section 140 divides space in which document objects are laid out into hierarchical levels, and determines a horizontal position of each document object in the layout according to the value of the hierarchical level attached to the document object. A vertical position of the document object is determined according to a condition of documents more closely related to each other being positioned closer to each other, and a condition of minimizing the number of crossing of association lines between document objects.

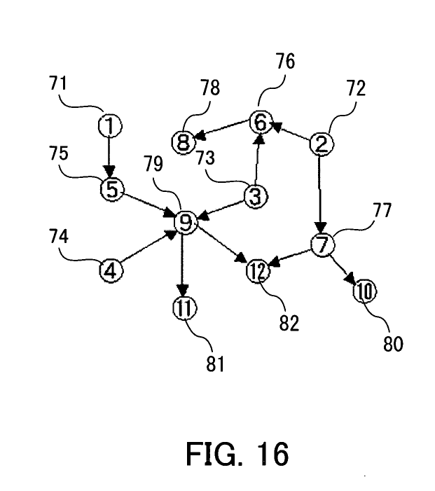

A description will be given of an example of the layout of document objects with reference to FIGS. 16 to 19. In FIGS. 16 to 19, each object is represented by a circle, and an identification number of each document object is shown within the circle.

FIG. 16 is a diagram showing document objects are arranged at random. In this example, twelve document objects 71 to 82 are arranged. The document objects 71 to 82 each have a valid association at least with one other document object, and the valid associations are indicated by arrows. When setting an arrow, two associated documents are compared in respect of time information, and the arrow is set to be directed from a document object older in time to a document object later in time. For example, the association between a document object 71 having an identification number “1” and a document object 75 having an identification number “5” is valid, and the document object 71 has older time information set thereto than time information set to the document object 75.

Then, the document objects 71 to 82 are arranged along the time axis.

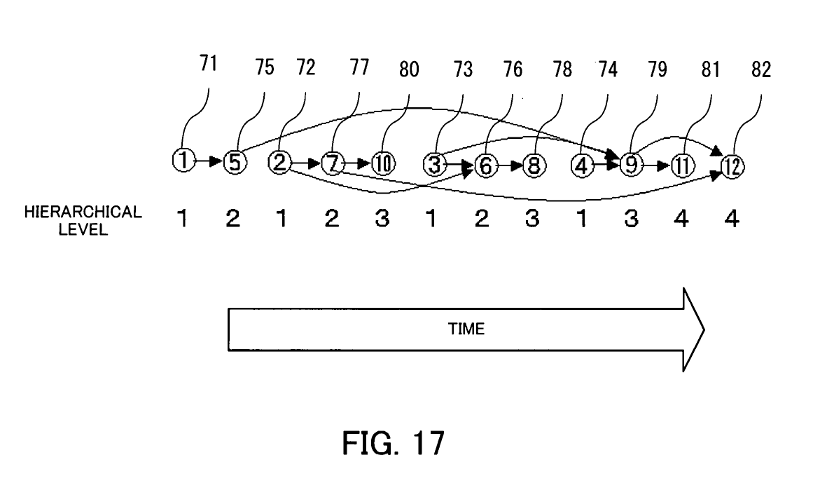

FIG. 17 is a diagram showing document objects arranged along the time axis. The arrangement of the document objects 71 to 82 along the time axis causes all the arrows to be directed to the direction of flow of time.

Thereafter, the hierarchical levels of the document objects 17 to 82 are determined. In the present embodiment, a value obtained by adding 1 to a value indicative of the hierarchical level of a document associated from the left side with a document object to be determined in respect of hierarchical level is determined to be the hierarchical level of the document to be determined. For example, with the document object 75 having the identification number 5, the document object 71 having the hierarchical level 1 is associated from the left side, and therefore, the hierarchical level of the document object 75 is 2. Further, with a document object 82 having an identification number 12, the two document objects 77 and 79 are associated from the left side. The document object 77 is at a hierarchical level of 2 and the document object 79 is at a hierarchical level of 3. If a plurality of documents are associated from the left side with one document object, as in this case, a value obtained by adding 1 to the highest value of the respective hierarchical levels of the documents is set to the hierarchical level of a document to be determined in respect of hierarchical level. Therefore, the hierarchical level of the document object 82 to be determined is 4.

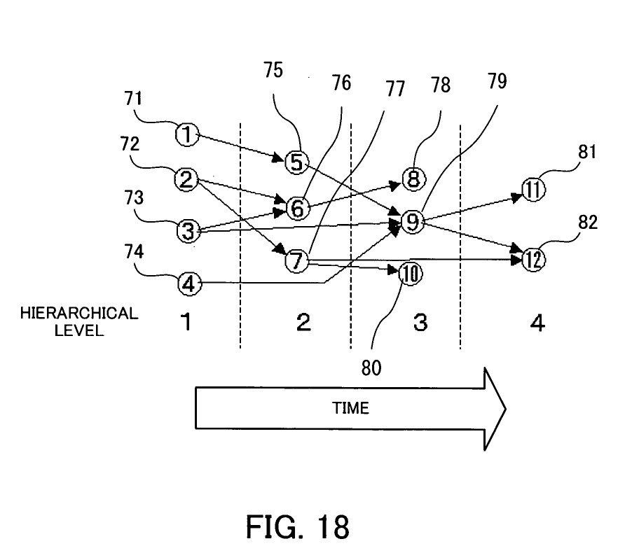

FIG. 18 is a diagram showing document objects arranged at hierarchical levels. In this figure, there are shown regions divided along the time axis, and the regions are assigned respective hierarchical levels. As the number or value of a hierarchical level is larger, it is assigned to a later or newer region along the time axis.

Then, a position of the document object in the vertical direction is determined. More specifically, the vertical position of each document object is determined such that there are a minimized number of crossing of association lines between document objects.

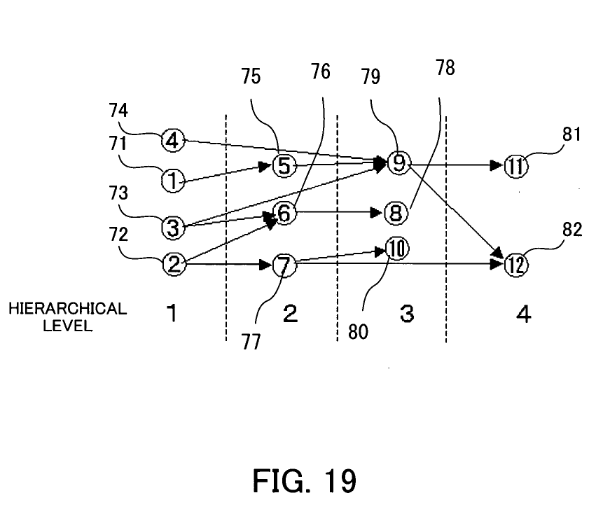

FIG. 19 is a diagram showing a relation chart in which the document objects are laid out in respective determined locations. In the illustrated example, the layout of document objects in the hierarchical level “1” is changed such that they are in the order of the document object 74, the document object 71, the document object 73, the document object 72, from top to bottom. Further, the layout of document objects in the hierarchical level “3” is changed such that they are in the order of the document object 79, the document object 78, the document object 80, from top to bottom. Thus, the documents are laid out in time series (chronological) order.

[Determination of Association Line Display Attributes (Step S16)]

Next, a method of reflecting relevancy between documents in the display attributes of association lines.

The associations validated between documents can be reflected in the display attributes of association lines by the following method:

The valid associations and other associations are expressed by different display attributes (e.g. colors or thickness of lines). For example, the association lines indicative of valid associations are highlighted. The method of highlighting includes e.g. a method of increasing the brightness of lines, a method of increasing the thickness of lines, and a method of using a conspicuous color, such as red, for lines.

Further, all the associations other than the valid ones can be made undisplayable. More specifically, by selecting the check box 95 on the thinning-out setting screen 90, the edges (association lines) discarded for thinning-out can be made transparent.

[Map Display (Step S17)]

The generated relation chart is displayed in a map by the output processing section 160.

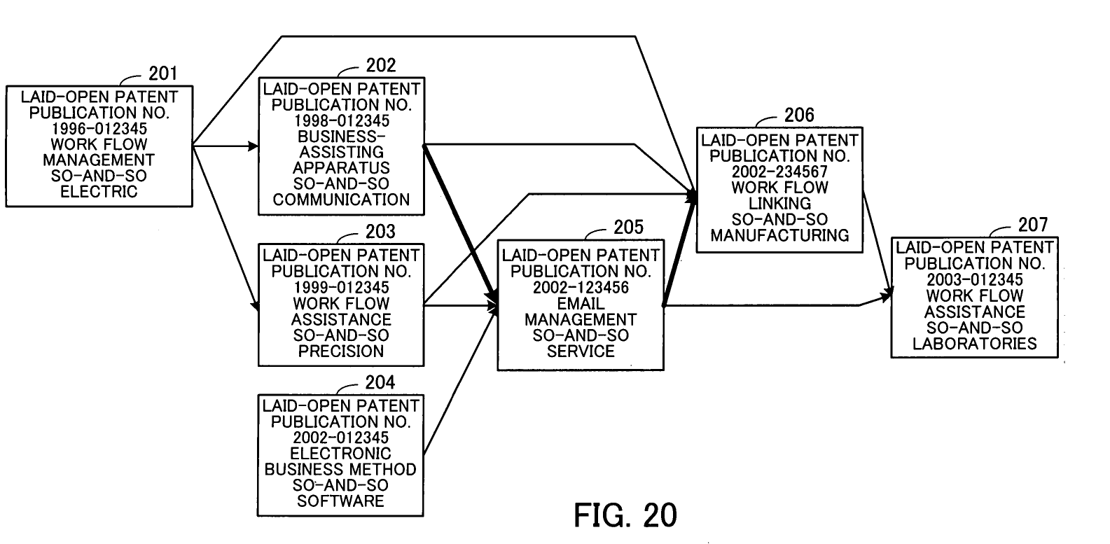

FIG. 20 is a diagram showing an example of a display of the relation chart, which shows the result obtained by inputting a set of patent documents. FIG. 20 shows seven document objects representing patent documents, respectively.

A document object 201 has valid associations with document objects 202, 203, and 206. In this case, the document object 201 has time information older than all of the document objects 202, 203, and 206 with which it has valid associations.

The document object 202 has valid associations with a document object 205 and the document object 206. In this case, the document object 202 has time information older than both of the document objects 205 and 206 with which it has valid associations.

The document object 202 and the document object 205 has a relatively high degree of relevancy, and therefore they are connected using a thick association line.

The document object 203 has valid associations with document objects 205 and 206. In this case, the document object 203 has time information older than both of the document objects 205 and 206 with which it has valid associations.

A document object 204 has a valid association with the document object 205. In this case, the document object 204 has time information older than the document object 205 with which it has a valid association.

The document object 205 has valid associations with the document object 206 and a document object 207. In this case, the document object 205 has time information older than both of the document objects 206 and 207 with which it has valid associations. The document object 205 and the document object 206 has a relatively high degree of relevancy, and therefore they are connected using a thick association line.

The document object 206 has a valid association with the document object 207. In this case, the document object 206 has time information older than the document object 207 with which it has the valid association.

Thus, lines representative of relations between the documents connect between the objects indicative of the documents, whereby the document objects can be displayed in chronological order.

### OTHER APPLIED EXAMPLES

Although in the above description, the layout of documents is calculated according to the valid associations between documents (association. information after thinning-out), this is not limitative, but the layout of documents can be calculated using association information of documents before thinning-out. Further, the association line display attributes may be also determined using the association information of documents before thinning-out, or the association information after thinning-out.

That is, there can be used the following four methods of document layout calculation and association line display attributes calculation (layout and the like-calculating methods).

[Layout and the like-calculating method a] The document association information before thinning-out is used for both of the calculation of a document layout and determination of association line display attributes.

[Layout and the like-calculating method b] The document association information after thinning-out is used for both of the calculation of a document layout and determination of association line display attributes.

[Layout and the like-calculating method c] The document association information before thinning-out is used for the calculation of a document layout, and the document association information after thinning-out is used for determination of association line display attributes.

[Layout and the like-calculating method d] The document association information after thinning-out is used for the calculation of a document layout, and the document association information before thinning-out is used for determination of association line display attributes.

For calculation of a document layout, it is possible to employ methods described in “Kozo Sugiyama, “Automatic Graph Drawing Method and Application thereof” Corona Publishing Co., Ltd. 1993”.

Further, in a relation chart, it is necessary to arrange objects in order along time. The method of creating a relation chart in which chronological order is preserved includes the following:

[Chronological order preservation method 1] Document objects are laid out such that chronological order is preserved among associated documents alone.

[Chronological order preservation method 2] Document objects are laid out such that chronological order is preserved all over the chart.

[Chronological order preservation method 3] Document objects are laid out such that chronological order is preserved in units of years, months, or days.

The above-described methods of document layout calculation and association line display attributes determination, and the methods of creating relation charts preserving chronological order can be used in any desired combination.

For example, FIG. 20 shows an example of [Layout and the like-calculating method b] and [Chronological order preservation method 1]. That is, the layout of documents is determined such that chronological order is preserved between documents for which the layout is calculated and the association lines are designated, using the association information after thinning-out, and then the association lines are drawn using the associations remaining after the thinning-out.

Further, it is possible to create relation charts using a combination of [Layout and the like-calculating method b] and [Chronological order preservation method 2].

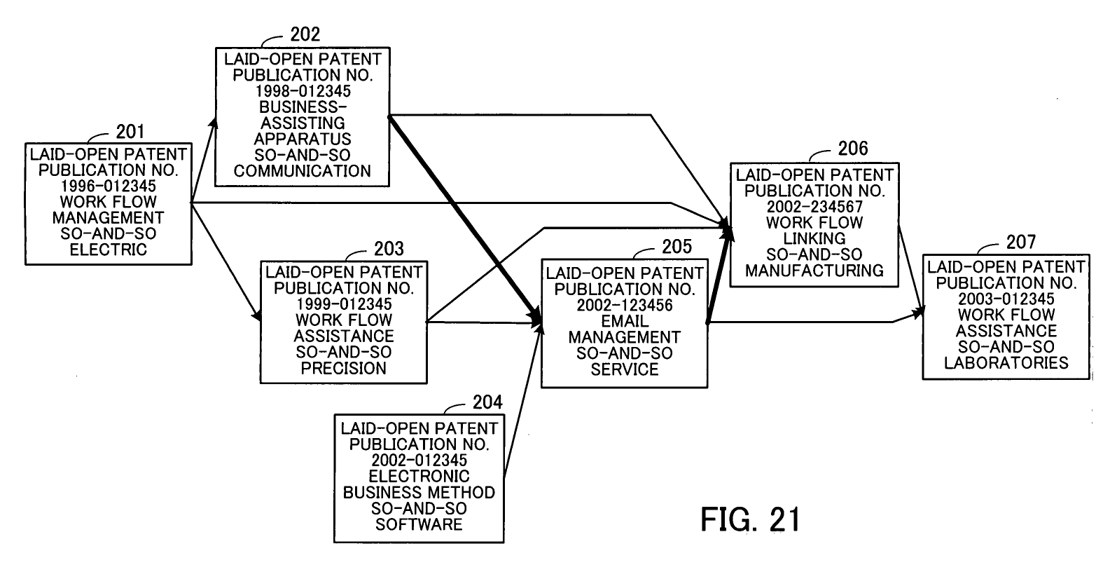

FIG. 21 is a diagram showing an example of a relation chart in which chronological order is persevered among all the documents. In FIG. 21, chronological order is preserved even in the document objects 202, 203, and 204 the associations between which are discarded for thinning-out. That is, the document objects 201 to 207 are displayed such that as the date set to a document as time information is earlier, the document is displayed at a location more shifted toward the left.

Further, it is possible to create a relation chart by a combination of [Layout and the like-calculating method d] and [Chronological order preservation method 1].

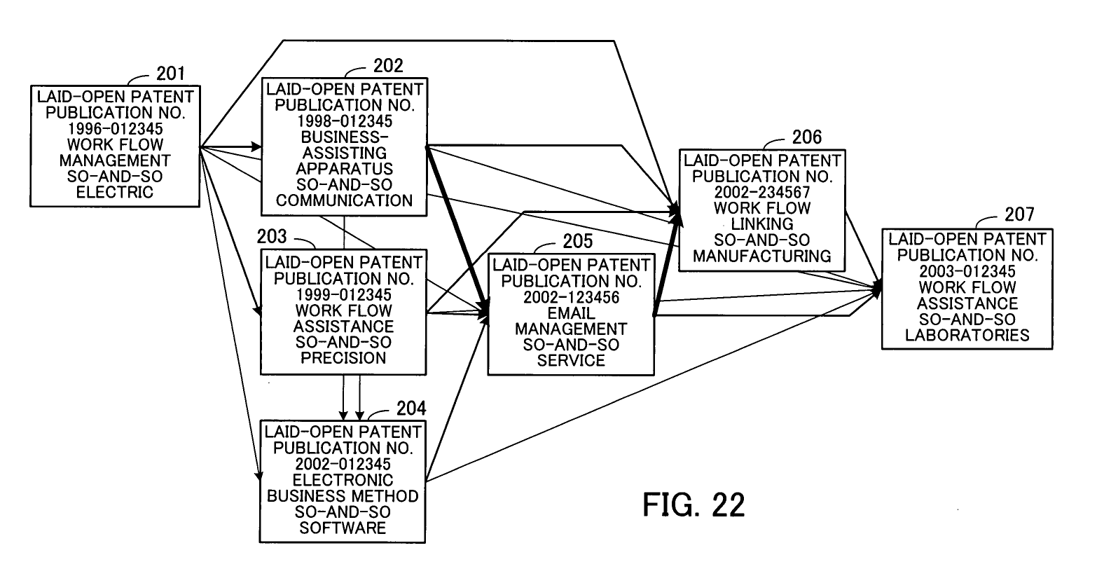

FIG. 22 is a diagram showing an example of a relation chart in which association lines are displayed including those indicative of associations before thinning-out. In FIG. 22, the layout of the document objects 201 to 207 is the same as that of the relation chart shown in FIG. 20. However, the association lines are before thinning-out, there are more association lines displayed. The associations to be discarded for thinning-out are displayed with thinner lines than the other association lines.

The time information used in the calculation of document layout includes a date of creation of a document or date of updating the same. Further, when time information is added as part of bibliographic information, such as a date of application, a date of publication, and a priority date, as in the case of patent documents, these pieces of information may be extracted to use the same as time information.

Further, in determining the layout of a relation chart, instead of singly using only one kind of time information, it is possible to use a plurality of kinds of time information in combination, e.g. such that when there is a priority date, the priority date is preferentially used, and when there is no priority date, a date of application is used. Such a combined use of time information can be applied not only to patent documents but also to various other kinds of documents. For example, when materials for consultation or papers for procedures have the same date of preparation, by using dates of update thereof, it is possible to apply the present method to automatic creation of a relation chart of documents with update history or a flow sheet of procedures.

When the citation relationship or reference relationship exists between documents, it is possible to perform the following processing by making use of information thereof. It should be noted that the citation relationship or reference relationship between documents can be extracted as one of feature elements by the feature element-extracting section 110.

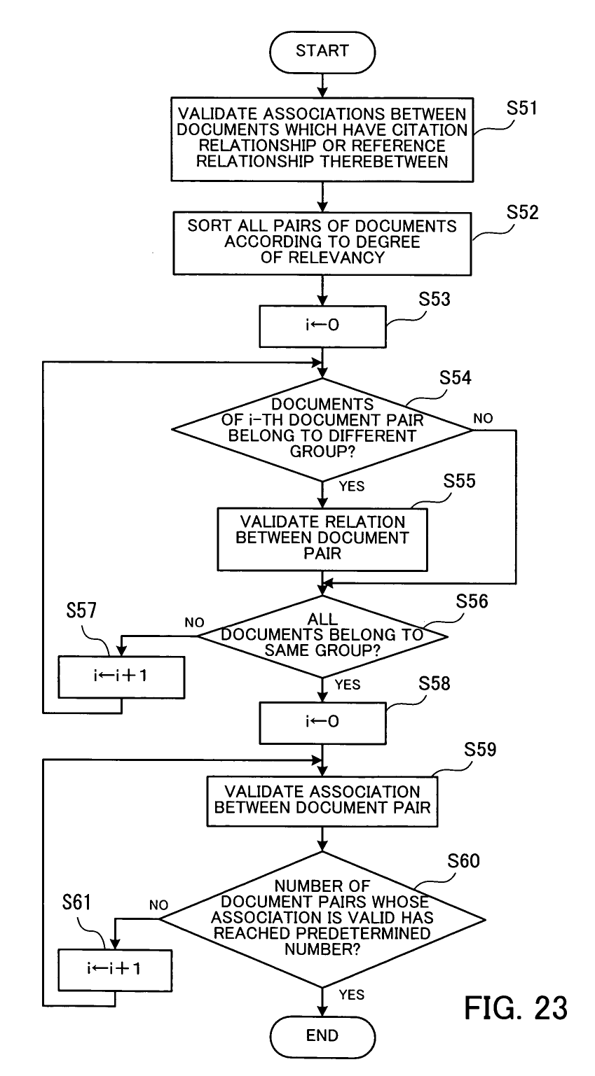

FIG. 23 is a flowchart showing a process of thinning out document associations when the citation relationship or reference relationship exists between documents. FIG. 23 is the same as the process shown in FIG. 12, except a step S51. That is, processing in each of a step S52 to a step S61 is the same as processing in the corresponding one of the step S21 to the step S30 in FIG. 12.

First, the association-thinning section 130 validates associations between documents which have citation relationship or reference relationship therebetween (step S51). This excludes the documents having the citation relationship or reference relationship therebetween, from being discarded for thinning-out. Then, the process proceeds to the step S52, and thereafter, the validation of associations between documents is carried out in the same procedure as described hereinabove with reference to FIG. 12.

Further, the method of causing the valid associations to be reflected in the calculation of document layout includes not only the above-described method, but also the following method: The document layout can be calculated using the associations validated by the citation relationship or reference relationship.

Further, the method of causing the valid associations to be reflected in the display attributes of association lines between documents includes the following method: Only associations having the citation relationship or reference relationship therebetween can be expressed using different display attributes (e.g. color or thickness of line).

When the relation chart is displayed, by making use of bibliographic information of documents, the corresponding document objects may be displayed by changing the display attributes thereof (e.g. color of frame or color of background). For example, in the case of patent documents, the same color may be used for frames of objects indicative of patent documents being the same applicant or IPC.

It should be noted that the processing functions described above can be realized by a computer. In this case, a program describing details of functions which a client should have is supplied. By executing the program on the computer, the above-described processing functions are realized on the computer. The program describing details of the processes can be recorded in a computer-readable recording medium. The computer-readable recording medium includes a magnetic recording device, an optical disk, a magneto-optical recording medium, and a semiconductor memory. The magnetic recording device includes a hard disk drive (HDD), a flexible disk (FD), and a magnetic tape. The optical disk includes a DVD (Digital Versatile Disk), a DVD-RAM (Random Access Memory), and a CD-ROM (Compact Disk Read Only Memory), and a CD-R (Recordable)/RW (ReWritable). Further, the magneto-optical recording medium includes an MO (Magneto-Optical disk).

To make the program available on the market, portable recording media, such as DVD and CD-ROM, which store the program, are sold. Further, the program can be stored in a storage device of a server computer connected to a network, and transferred from the server computer to another computer via the network.

When the program is executed by a computer, the program stored e.g. in a portable recording medium or transferred from the server computer is stored into a storage device of the computer. Then, the computer reads the program from the storage device of its own and executes processing based on the program. The computer can also read the program directly from the portable recording medium and execute processing based on the program. Further, the computer may also execute processing based on a program which is transferred from the server computer whenever the processing is to be carried out.

As described above, according to the present invention, feature elements including time information are extracted from documents, the degree of relevancy between the documents is calculated based on the feature elements, and the objects indicative of the documents are arranged along the time axis based on the time information. Therefore, it is possible to grasp the relations between the documents in chronological order with ease.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A relation chart-creating program for creating a relation chart representative of relations between a plurality of documents, the program causing a computer to:
analyze contents of each of the documents and extract feature elements including time information therefrom;
calculate a degree of relevancy between each document pair extracted from the documents, based on the extracted feature elements;
lay out objects indicative of the documents, along a time axis, based on the time information, and generate association lines for connecting between the objects of each document pair, depending on the calculated degree of relevancy; and
display the relation chart composed of the objects and the association lines.

2. The relation chart-creating program according to claim 1, wherein when the association lines are generated, the association lines between predetermined ones of the document pairs are discarded for thinning-out based on the degree of relevancy of the document pair without citation relationship.

3. The relation chart-creating program according to claim 1, wherein when the association lines are generated, ones of the association lines between ones of the document pairs having the citation relationship are displayed in a form of display different from a form of display in which the others of the association lines are displayed.

4. The relation chart-creating program according to claim 1, wherein when the objects indicative of the documents are laid out, at least ones of the objects indicative of the document pairs having relevancy are arranged along the time axis in an order based on the time information.

5. The relation chart-creating program according to claim 1, wherein when the objects indicative of the documents are laid out, the objects indicative of the documents are arranged along the time axis in an order based on the time information.

6. The relation chart-creating program according to claim 1, wherein when the objects indicative of the documents are laid out, the time axis is represented in basic units each corresponding to a predetermined time period, and the order along the time axis is preserved between objects indicative of the documents belonging to different ones of the time periods.

7. The relation chart-creating program according to claim 1, wherein assuming that patent documents are inputted as the plurality of documents, in extracting the feature elements, dates of application are extracted as the time information.

8. The relation chart-creating program according to claim 1, wherein assuming that patent documents are inputted as the plurality of documents, in extracting the feature elements, dates of application and priority dates are extracted as the time information, and
wherein when the objects indicative of the documents are laid out, if a date of application and a priority date have been extracted from a document, the priority date is regarded as the time information of the document.

9. A method of creating a relation chart representative of relations between a plurality of documents, comprising the steps of:
analyzing contents of each of the documents and extracting feature elements including time information therefrom;
calculating a degree of relevancy between each document pair extracted from the documents, based on the extracted feature elements;
laying out objects indicative of the documents, along a time axis, based on the time information, and generating association lines for connecting between the objects of each document pair, depending on the calculated degree of relevancy; and
displaying the relation chart composed of the objects and the association lines.

10. A relation chart-creating apparatus for creating a relation chart representative of relations between a plurality of documents, comprising:
feature element-extracting means for analyzing contents of each of the documents and extracting feature elements including time information;
relevancy-calculating means for calculating a degree of relevancy between each document pair extracted from the documents, based on the extracted feature elements;
layout means for laying out objects indicative of the documents, along a time axis, based on the time information;
association line-generating means for generating association lines for connecting between the objects of each document pair, depending on the calculated degree of relevancy; and
display means for displaying the relation chart composed of the objects and the association lines.

11. A computer-readable recording medium that records a relation chart-creating program for creating a relation chart representative of relations between a plurality of documents, the program causing a computer to:
analyze contents of each of the documents and extract feature elements including time information therefrom;
calculate a degree of relevancy between each document pair extracted from the documents, based on the extracted feature elements;
lay out objects indicative of the documents, along a time axis, based on the time information, and generate association lines for connecting between the objects of each document pair, depending on the calculated degree of relevancy; and
display the relation chart composed of the objects and the association lines.
